(19) United States
(12) Patent Application Publication
(10) Pub. No.: US 2024/0069563 A1
(43) Pub. Date: Feb. 29, 2024

(54) ROBOT DEVICE FOR IDENTIFYING MOVEMENT PATH USING RELIABILITY VALUE AND CONTROL METHOD THEREOF

(71) Applicant: SAMSUNG ELECTRONICS CO., LTD., Suwon-si (KR)

(72) Inventors: Soonbeom KWON, Suwon-si (KR); Jaeha LEE, Suwon-si (KR); Mideum CHOI, Suwon-si (KR); Junyeong CHOI, Suwon-si (KR)

(73) Assignee: SAMSUNG ELECTRONICS CO., LTD., Suwon-si (KR)

(21) Appl. No.: 18/238,902

(22) Filed: Aug. 28, 2023

Related U.S. Application Data
(63) Continuation of application No. PCT/KR2023/011579, filed on Aug. 7, 2023.

(30) Foreign Application Priority Data
Aug. 23, 2022 (KR) 10-2022-0105742

(51) Int. Cl. G05D 1/02

(52) U.S. Cl. CPC G05D 1/0274; G05D 1/0248; G05D 2201/0203

(57) ABSTRACT

Provided is a robot device and a method of controlling same. The robot device includes: at least one memory storing at least one instruction; a sensor configured to detect an environment of the robot device and output detection data; and at least one processor configured to execute the at least one instruction to: acquire a map of a space where the robot device is positioned based on the detection data received from the sensor, and a reliability value of each of a plurality of areas of the map, store the map and the reliability value of each of the plurality of areas in the at least one memory, identify at least one area having a reliability value greater than or equal to a critical value, based on the reliability value of each of the plurality of areas, and identify a movement path of the robot device in the space, based on the at least one area.

### CROSS-REFERENCE TO RELATED APPLICATIONS

This application is a bypass continuation of International Application No. PCT/KR2023/011579, filed on Aug. 7, 2023, which is based on and claims priority to Korean Patent Application No. 10-2022-0105742, filed on Aug. 23, 2022, in the Korean Intellectual Property Office, the disclosures of which are incorporated by reference herein in their entireties.

### BACKGROUND

### 1. Field

The disclosure relates to a robot device and a control method thereof, and more particularly, to a robot device for identifying a movement path using a reliability value, and a control method thereof.

### 2. Description of Related Art

Various types of robot devices traveling in a space and performing a specific action have become popular, such as a serving robot replacing a person in a store, a cafe or a restaurant, a robot cleaner automatically cleaning an area to be cleaned by suctioning a foreign material while traveling on its own even without a user's separate operation, or the like.

In the related art, the robot device may obtain a map, estimate its position in the map, and move along a movement path. However, as the robot device is moved, an error between the estimated position and an actual position may be accumulated, which results in a significant deviation.

For example, the robot device may estimate that the robot device itself is positioned at an end point in the map at the end point of the movement path. However, the robot device may be actually positioned in a completely different place rather than the end point of the movement path.

That is, there has been a demand for a method of identifying a degree of the error between a position of the robot device estimated by the robot device itself and its actual position, and setting (or resetting) the movement path in consideration of the error while the robot device is moved along the movement path.

### SUMMARY

According to an aspect of the disclosure, a robot device includes: at least one memory storing at least one instruction; a sensor configured to detect an environment of the robot device and output detection data; and at least one processor configured to execute the at least one instruction to: acquire a map of a space where the robot device is positioned based on the detection data received from the sensor, and a reliability value of each of a plurality of areas of the map, store the map and the reliability value of each of the plurality of areas in the at least one memory, identify at least one area having a reliability value greater than or equal to a critical value, based on the reliability value of each of the plurality of areas, and identify a movement path of the robot device in the space, based on the at least one area.

The at least one processor of the robot device may be further configured to execute the at least one instruction to: estimate, based on the detection data, an area of the plurality of areas as a position of the robot device, and obtain an estimated reliability value corresponding to the estimated position of the robot device by determining a probability that the estimated position of the robot device and an actual position of the robot device match each other.

The at least one processor of the robot device may be further configured to execute the at least one instruction to: acquire movement information of the robot device based on first detection data and second detection data that are consecutively received from the sensor, and estimate a new position of the robot device corresponding to the second detection data, based on the movement information.

The sensor may include a light detection and ranging (LiDAR) sensor, the first detection data may include first point cloud data received from the LiDAR sensor, the second detection data may include second point cloud data received from the LiDAR sensor, and the at least one processor of the robot device may be further configured to execute the at least one instruction to: perform an operation to combine a plurality of point clouds based on the first point cloud data and the second point cloud data, and based on a failure of the operation to combine the plurality of point clouds, obtain an updated reliability value corresponding to the new position of the robot device, wherein the updated reliability value is less than the critical value.

The sensor may include a camera, the first detection data may include first image data received from the camera, the second detection data may include second image data received from the camera, and the at least one processor of the robot device may be further configured to execute the at least one instruction to: identify a dynamic object based on the first image data and the second image data, and based on a number of dynamic objects being greater than or equal to a critical number, obtain an updated reliability value corresponding to the new position of the robot device, wherein the updated reliability value is less than the critical value.

The sensor may include a camera, the detection data may include image data received through the camera, and the at least one processor of the robot device may be further configured to execute the at least one instruction to: identify a field of view of the camera based on the image data, and based on an angle of the field of view being less than a critical angle, obtain an updated reliability value corresponding to the new position of the robot device, wherein the updated reliability value is less than the critical value.

The movement information may include a movement direction of the robot device, a movement distance of the robot device, or a movement speed of the robot device, and the at least one processor of the robot device may be further configured to execute the at least one instruction to: based on identifying an inability to maintain at least one of the movement direction of the robot device, the movement distance of the robot device, and the movement speed of the robot device, obtain an updated reliability value corresponding to the new position of the robot device, wherein the updated reliability value is less than the critical value.

The at least one processor of the robot device may be further configured to execute the at least one instruction to update, in the at least one memory, the reliability value corresponding to an area of the plurality of areas, based on the acquired reliability value.

The sensor may include a light detection and ranging (LiDAR) sensor, and the at least one processor of the robot device may be further configured to execute the at least one instruction to: identify an error value based on an orientation of the LiDAR sensor in an area of the plurality of areas based on the detection data received from the LiDAR sensor, and adjust the orientation of the LiDAR sensor based on the error value while the robot device moves along the movement path in the area of the plurality of areas.

The at least one processor of the robot device may be further configured to execute the at least one instruction to: based on identifying an area of the plurality of areas having a reliability value less than the critical value, modify the movement path to bypass the identified area.

According to an aspect of the disclosure, a method of controlling a robot device includes: acquiring a map of a space where the robot device is positioned, wherein the map comprises a plurality of areas and each area of the plurality of areas has a corresponding reliability value; identifying at least one area, among the plurality of areas, having a reliability value greater than or equal to a critical value, based on the reliability value of each of the plurality of areas; and identifying a movement path of the robot device in the space, based on the at least one area.

The method of controlling the robot device may further include: estimating, based on detection data of a sensor of the robot device, an area of the plurality of areas as a position of the robot device; and obtaining an estimated reliability value corresponding to the estimated position of the robot device by determining a probability that the estimated position of the robot device and an actual position of the robot device match each other.

The estimating may include: acquiring movement information of the robot device based on first detection data and second detection data that are consecutively received from the sensor; and estimating, based on the movement information, a new position of the robot device corresponding to the second detection data.

The sensor may include a light detection and ranging (LiDAR) sensor, the first detection data may include first point cloud data received from the LiDAR sensor, the second detection data may include second point cloud data received from the LiDAR sensor, and the obtaining an estimated reliability value may include: performing an operation to combine a plurality of point clouds based on the first point cloud data and the second point cloud data; and based on a failure of the operation to combine the plurality of point clouds, obtaining an updated reliability value corresponding to the new position of the robot device, wherein the updated reliability value is less than the critical value.

The sensor may include a camera, the first detection data may include first image data received from the camera, the second detection data may include second image data received from the camera, and the obtaining the estimated reliability value may include: identifying a dynamic object based on the first image data and the second image data; and based on a number of dynamic objects being greater than or equal to a critical number, obtaining an updated reliability value corresponding to the new position of the robot device, wherein the updated reliability value is less than the critical value.

According to an aspect of the disclosure, a non-transitory computer readable medium includes instructions stored therein, which when executed by a processor cause the processor to execute a method of controlling a robot device, the method including: acquiring a map of a space where the robot device is positioned, wherein the map comprises a plurality of areas, and each area of the plurality of areas has a corresponding reliability value; identifying at least one area among the plurality of areas having a reliability value greater than or equal to a critical value, based on the reliability value of each of the plurality of areas; and identifying a movement path of the robot device in the space, based on the at least one area.

The non-transitory computer readable medium, wherein the method may further include: estimating, based on detection data of a sensor of the robot device, an area of the plurality of areas as a position of the robot device; and obtaining an estimated reliability value corresponding to the estimated position of the robot device by calculating a probability that the estimated position of the robot device and an actual position of the robot device match each other.

The non-transitory computer readable medium, wherein the estimating may include: acquiring movement information of the robot device based on first detection data and second detection data that are consecutively received from the sensor; and estimating, based on the movement information, a new position of the robot device corresponding to the second detection data.

The non-transitory computer readable medium, wherein the sensor may include a light detection and ranging (LiDAR) sensor, the first detection data may include first point cloud data received from the LiDAR sensor, the second detection data may include second point cloud data received from the LiDAR sensor, and the obtaining an estimated reliability value may include: attempting to combine a plurality of point clouds based on the first point cloud data and the second point cloud data; and based on a failure of the attempting to combine the plurality of point clouds, obtaining an updated reliability value corresponding to the new position of the robot device, wherein the updated reliability value is less than the critical value.

The non-transitory computer readable medium, wherein the sensor may include a camera, the first detection data may include first image data received from the camera, the second detection data may include second image data received from the camera, and the obtaining the estimated reliability value may include: identifying a dynamic object based on the first image data and the second image data; and based on a number of dynamic objects being greater than or equal to a critical number, obtaining an updated reliability value corresponding to the new position of the robot device, wherein the updated reliability value is less than the critical value.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view for explaining a robot device according to one or more embodiments of the disclosure;

FIG. 2 is a block diagram showing a configuration of the robot device according to one or more embodiments of the disclosure;

FIG. 3 is a view for explaining a map of a space where the robot device is positioned according to one or more embodiments of the disclosure;

FIG. 4 is a view for explaining movement information of the robot device according to one or more embodiments of the disclosure;

FIG. 5 is a view for explaining a plurality of areas included in the map according to one or more embodiments of the disclosure;

FIG. 6 is a view for explaining a method of estimating a position of the robot device according to one or more embodiments of the disclosure;

FIG. 7 is a view for explaining point cloud data according to one or more embodiments of the disclosure;

FIG. 8 is a view for explaining a dynamic object according to one or more embodiments of the disclosure;

FIG. 9 is a view for explaining a field of view (FOV) according to one or more embodiments of the disclosure; and

FIG. 10 is a flowchart for explaining a control method of a robot device according to one or more embodiments of the disclosure.

### DETAILED DESCRIPTION

Hereinafter, the disclosure is described in detail with reference to the accompanying drawings.

General terms that are currently widely used are selected as terms used in embodiments of the disclosure in consideration of functions in the disclosure, and may be changed based on the intention of those skilled in the art or a judicial precedent, the emergence of a new technique, and the like. In addition, in a specific case, terms arbitrarily chosen by an applicant may exist. In this case, the meanings of such terms are mentioned in detail in corresponding descriptions of the disclosure. Therefore, the terms used in the embodiments of the disclosure need to be defined on the basis of the meanings of the terms and the contents throughout the disclosure rather than simple names of the terms.

In the disclosure, an expression “have,” “may have,” “include,” “may include” or the like, indicates the existence of a corresponding feature (for example, a numerical value, a function, an operation or a component such as a part), and does not exclude the existence of an additional feature.

The expression, “at least one of A or B” may indicate only A, only B, or both of A and B.

Expressions “first,” “second,” and the like, used in the disclosure may indicate various components regardless of a sequence or importance of the components. These expressions are used only to distinguish one component from another component, and do not limit the corresponding components.

In case that any component (for example, a first component) is mentioned to be “(operatively or communicatively) coupled with/to” or “connected to” another component (for example, a second component), it is to be understood that any component may be directly coupled to another component or may be coupled to another component through still another component (for example, a third component).

A term of a singular number may include its plural number unless explicitly indicated otherwise in the context. It is to be understood that a term “include,” “formed of,” or the like used in the present application specifies the presence of features, numerals, steps, operations, components, parts, or combinations thereof, mentioned in the specification, and does not preclude the presence or addition of one or more other features, numerals, steps, operations, components, parts, or combinations thereof.

In the embodiments, a “module” or a “˜er/˜or” may perform at least one function or operation, and be implemented by hardware or software or be implemented by a combination of hardware and software. In addition, a plurality of “modules” or a plurality of “˜ers/˜ors” may be integrated in at least one module and implemented by at least one processor except for a “module” or a “˜er/or” that needs to be implemented by specific hardware.

In the specification, such a term as “user” may refer to a person who uses an electronic device or a device (e.g., artificial intelligence electronic device) which uses an electronic device.

Hereinafter, the embodiments of the disclosure are described in detail with reference to the accompanying drawings.

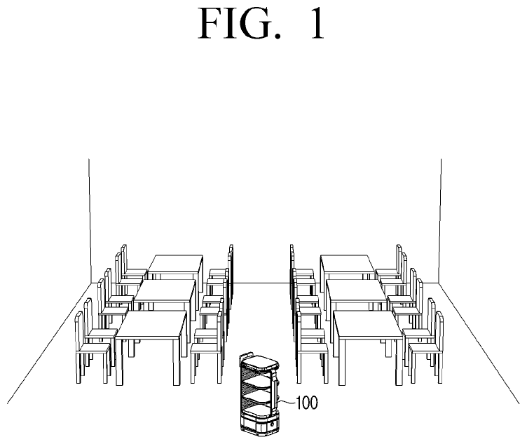

FIG. 1 is a view for explaining a robot device according to one or more embodiments of the disclosure.

As shown in FIG. 1, a robot device 100 may refer to various types of devices having ability to perform a function for itself. For example, the robot device 100 may be a smart device autonomously operated by detecting a surrounding environment of the robot device 100 in real time based on detection data of a sensor (e.g., light detection and ranging (LiDAR) sensor or camera) and collecting information in addition to performing a simple and repetitive function.

The robot device 100 according to one or more embodiments of the disclosure may include a driver including an actuator or a motor. The driver according to one or more embodiments may include a wheel, a brake, or the like, and the robot device 100 may move itself in a specific space by using the wheel, the brake, or the like, included in the driver.

The robot device 100 according to one or more embodiments may control movement (or articulation) of a robot joint by using the driver. Here, the robot joint may be one component of the robot device 100 for substituting a function of a human arm or hand.

The robot device 100 according to one or more embodiments of the disclosure may detect the surrounding environment of the robot device 100 in real time based on the detection data of the sensor. Next, the robot device 100 may control the driver based on the detected surrounding environment. For example, the robot device 100 may identify a movement path of the robot device 100 based on the detection data of the sensor.

For example, the robot device 100 may acquire a map of a space where the robot device 100 is positioned based on the detection data, and identify a position of the robot device 100 on the map. For example, the robot device 100 may identify its position in real time and move in the space along the movement path. Therefore, the robot device 100 may need to identify its position with accuracy (or with high reliability) to move in the space along the movement path.

Hereinafter, the description describes various embodiments in which the robot device 100 identifies its position on the map and identifies the movement path by considering whether the identified position matches a current position (or actual position) of the robot device 100 in the space.

The robot device 100 may be classified into a robot device for industrial, medical, household, military, or exploration use based on its field or its function which may be performed. According to one or more embodiments, the industrial robot device may be subdivided into a robot device used in a product-manufacturing process of a factory, a robot device serving a customer, receiving an order, and providing the serving, or the like in a store or a restaurant. For example, as shown in FIG. 1, the robot device 100 may be implemented as a serving robot device which may transport a service item to a position desired by a user or to a specific position in any of various places such as a restaurant, a hotel, a mart, a hospital, a clothing store, and the like.

However, this implementation is only an example, and the robot device 100 may be classified into various types based on its application field, function, and purpose of use, and is not limited to the above-described examples.

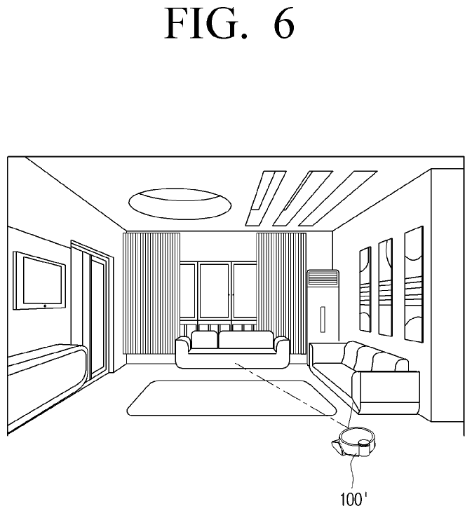

For example, as shown in FIG. 6, the robot device 100 may be implemented as a robot cleaner positioned in a house. Here, the robot cleaner may be a device driven by electric power and automatically suctioning a foreign material. Hereinafter, for convenience of explanation, it is assumed that the robot device 100 is the robot cleaner, and the robot cleaner is implemented as a flat-type in close contact with a floor to suction the foreign material on the floor. However, this implementation is only an example, and the robot device 100 may be implemented in various forms as described above.

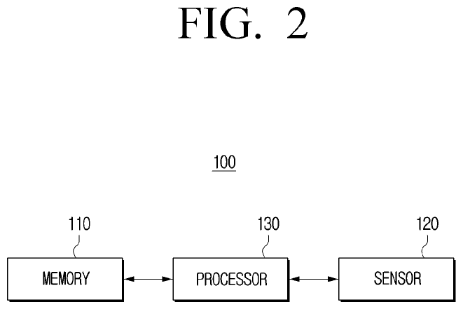

FIG. 2 is a block diagram showing a configuration of the robot device according to one or more embodiments of the disclosure.

The robot device 100 according to one or more embodiments may include a memory 110, a sensor 120, and at least one processor 130 (hereafter referred to as a processor).

The memory 110 according to one or more embodiments may store data required for various embodiments of the disclosure. The memory 110 may be implemented as a memory embedded in the robot device 100, or implemented as a memory detachable from the robot device 100, based on a data storage purpose. For example, data for driving the robot device 100 may be stored in the memory embedded in the robot device 100, and data for an extension function of the robot device 100 may be stored in the memory detachable from the robot device 100.

The memory embedded in the robot device 100 may be implemented as at least one of a volatile memory (for example, a dynamic random access memory (DRAM), a static RAM (SRAM), or a synchronous dynamic RAM (SDRAM)), a non-volatile memory (for example, an one time programmable read only memory (OTPROM), a programmable ROM (PROM), an erasable and programmable ROM (EPROM), an electrically erasable and programmable ROM (EEPROM), a mask ROM, or a flash ROM), a flash memory (for example, a NAND flash, or a NOR flash), a hard drive, or a solid state drive (SSD)). In addition, the memory detachable from the robot device 100 may be implemented in the form of a memory card (for example, a compact flash (CF), a secure digital (SD), a micro secure digital (Micro-SD), a mini secure digital (Mini-SD), an extreme digital (xD), or a multi-media card (MMC)), or an external memory (for example, a USB memory) which may be connected to a universal serial bus (USB) port.

For example, the memory 110 may store at least one instruction for controlling the robot device 100 or a computer program including the instructions.

According to one or more embodiments of the disclosure, various data may be stored in an external memory of the processor 130, some of the data may be stored in an internal memory of the processor 130, and the rest may be stored in the external memory.

In particular, the memory 110 may store the map of the space where the robot device 100 is positioned under control of the processor 130.

For example, the processor 130 may acquire the map of the space where the robot device 100 is positioned based on the detection data received from the sensor 120, and store the map in the memory 110.

Here, the sensor 120 may include the LiDAR sensor, the camera, or the like.

For example, the processor 130 may detect the surrounding environment of the robot device 100 by controlling the LiDAR sensor to emit a laser beam, and the LiDAR sensor may acquire, as the detection data, a distance to an object adjacent to the robot device 100, a direction in which the object is positioned relative to the robot device 100, and a feature of the object. Next, the processor 130 may acquire the surrounding environment of the robot device 100 as two-dimensional (2D)/three-dimensional (3D) image information (e.g., map) based on the detection data.

For example, the processor 130 may acquire image data by controlling the camera to detect the surrounding environment of the robot device 100. Here, the camera may acquire the image data by capturing the surrounding environment of the robot device 100 under the control of the processor 130, and transmit the acquired image data to the processor 130. Next, the processor 130 may analyze the image data to acquire the distance to the object adjacent to the robot device 100, the direction in which the object is positioned relative to the robot device 100, and the feature of the object, and acquire the surrounding environment of the robot device 100 as the 2D/3D image information (e.g., map).

The sensor 120 is not limited to the above example, and may include various types of sensors which may detect the surrounding environment of the robot device 100 in addition to the LiDAR sensor or the camera.

At least one processor 130 according to one or more embodiments of the disclosure may control overall operations of the robot device 100.

According to one or more embodiments of the disclosure, the processor 130 may be implemented as a digital signal processor (DSP) processing a digital signal, a microprocessor, or a time controller (TCON). However, the processor 130 is not limited thereto, and may include one or more of a central processing unit (CPU), a micro controller unit (MCU), a micro processing unit (MPU), a controller, an application processor (AP), a communication processor (CP), an advanced reduced instruction set computer (RISC) machines (ARM) processor or an artificial intelligence (AI) processor, or may be defined by this term. In addition, the processor 130 may be implemented in a system-on-chip (SoC) or a large scale integration (LSI) in which a processing algorithm is embedded, or may be implemented in the form of a field programmable gate array (FPGA). The processor 130 may perform various functions by executing computer executable instructions stored in the memory.

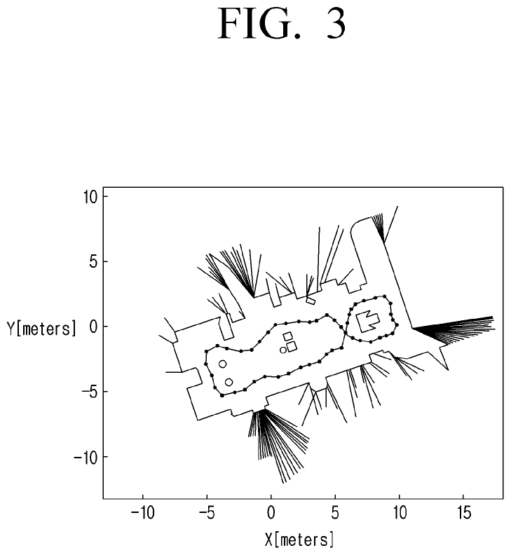

FIG. 3 is a view for explaining the map of the space where the robot device is positioned according to one or more embodiments of the disclosure.

The processor 130 according to one or more embodiments of the disclosure may acquire the map of the space where the robot device 100 is positioned by performing a simultaneous localization and mapping (SLAM) operation.

Here, the SLAM operation may be an operation of acquiring the map of the space where the robot device 100 is positioned using the detection data received from the sensor 120, and identifying the position of the robot device 100 on the map.

For example, the processor 130 may estimate the position of the robot device 100 on the map based on the detection data received from the sensor 120.

For example, the processor 130 may acquire movement information of the robot device 100 based on the first detection data and the second detection data in case of sequentially (or consecutively) receiving first detection data and second detection data.

Next, the processor 130 may estimate the position of the robot device 100 on the map at a time point at which the second detection data is received based on the movement information.

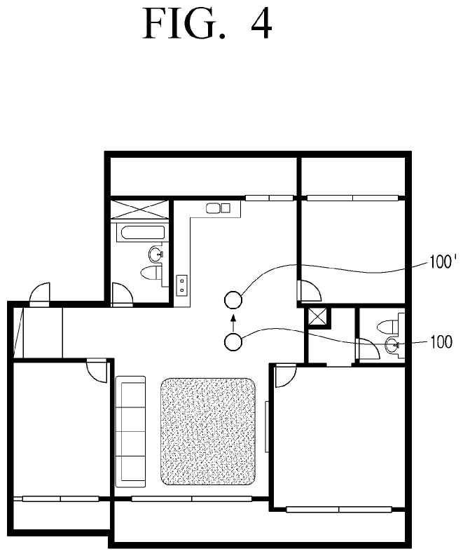

FIG. 4 is a view for explaining the movement information of the robot device according to one or more embodiments of the disclosure.

Referring to FIG. 4, the sensor 120 positioned in the robot device 100 may acquire the first detection data at a time point t, and transmit the acquired first detection data to the processor 130.

Next, the sensor 120 positioned in a robot device 100′ (robot device 100′ is the same as robot device 100, but shifted forward in time) may acquire the second detection data at a time point t+1, and transmit the acquired second detection data to the processor 130.

Next, the processor 130 may acquire movement information of the robot device 100 from the time point t to the time point t+1 based on the first detection data and the second detection data. The processor 130 according to one or more embodiments may estimate a position of the robot device 100′ on the map at the time point t+1 based on the movement information.

For example, the sensor 120 may include the LiDAR sensor. The processor 130 may combine (register or align) point clouds to each other based on first point cloud data included in the first detection data and second point cloud data included in the second detection data, received from the LiDAR sensor.

For example, the processor 130 may combine the first point cloud data and the second point cloud data to each other by using LiDAR odometry (e.g., iterative closest point (ICP) algorithm or Normal Distributions Transform (NDT)). Next, the processor 130 may estimate the position (or a movement trajectory) of the robot device 100′ based on a result of combining the first point cloud data and the second point cloud data to each other.

For example, the sensor 120 may include the camera. The processor 130 may acquire the movement information of the robot device 100 from the time point t to the time point t+1 based on first image data included in the first detection data and second image data included in the second detection data, received from the camera.

For example, the processor 130 may analyze the first image data to identify a feature of at least one object (e.g., geometric feature of at least one object) included in the first image data, and analyze the second image data to identify a feature of at least one object included in the second image data.

Next, the processor 130 may acquire the movement information of the robot device 100 from the time point t to the time point t+1 by comparing the feature of at least one object included in the first image data with the feature of at least one object included in the second image data with each other.

Next, the processor 130 may estimate the position (or a movement trajectory) of the robot device 100′ based on the movement information.

Here, the sensor 120 may include at least one of the LiDAR sensor or the camera.

The processor 130 according to one or more embodiments may estimate the real-time position of the robot device 100 on the map based on the plurality of detection data received in real time or sequentially from the sensor 120 while the robot device 100 is moved in the space.

The processor 130 according to one or more embodiments may identify a probability that the estimated position of the robot device 100 on the map and its actual position in the space match each other.

For example, the processor 130 may identify whether the estimated position of the robot device 100 is reliable as its actual position, that is, the probability (hereinafter, a reliability value) that the estimated position matches its actual position.

Here, the reliability value may represent reliability for the estimated position based on the movement information, and thus be inversely proportional to a position-measurement failure value (or localization failure value (LFV)).

For example, in case that the reliability value is high, the estimated position of the robot device 100 based on the movement information may be highly likely to match its actual position, and the localization failure value may be low. On the other hand, in case that the reliability value is low, the estimated position of the robot device 100 based on the movement information may be scarcely likely to match its actual position, and the localization failure value may be high.

The processor 130 according to one or more embodiments may classify the map into the plurality of areas, and acquire and store the reliability value of each of the plurality of areas.

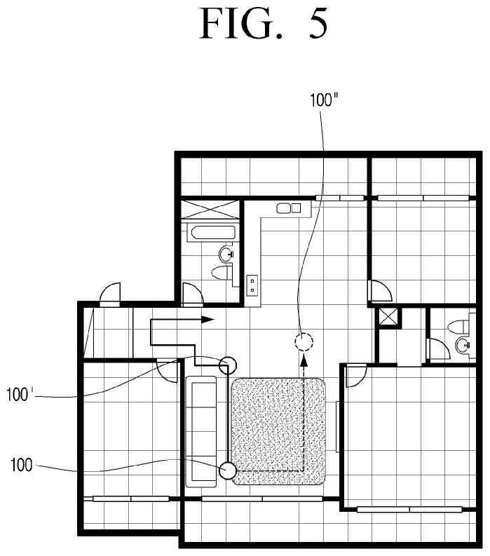

FIG. 5 is a view for explaining a plurality of areas included in the map according to one or more embodiments of the disclosure.

Referring to FIG. 5, the map may be classified into a plurality of areas. Each of the plurality of areas may be referred to as a cell, and which is hereinafter collectively referred to as an area for convenience of explanation. Meanwhile, each size of the plurality of areas shown in FIG. 5 is an example, and is not limited thereto.

The processor 130 according to one or more embodiments may estimate the real-time position of the robot device 100 based on the plurality of detection data received in real time or sequentially from the sensor 120 while the robot device 100 moves.

Next, the processor 130 may identify the reliability value, i.e. the probability that the estimated position of the robot device 100 matches its actual position, and map the identified reliability value and an area corresponding to the estimated position among the plurality of areas to each other.

Therefore, the processor 130 may identify the reliability value of each of the plurality of areas, and acquire a reliability value map (or a localization failure value (LFV) map (hereinafter referred to as the LFV Map)) corresponding to the map.

For example, the processor 130 may acquire the probability that the estimated position of the robot device 100 matches its actual position from the reliability value map in a case where the estimated position corresponds to any one of the plurality of areas of the robot device 100.

The processor 130 may need to identify an appropriate movement path in the space, and may estimate the position of the robot device on the map with accuracy (or with high reliability) to accurately move the robot device 100 along the identified movement path.

The processor 130 according to one or more embodiments may identify at least one area having a reliability value greater than or equal to a critical value based on the reliability value of each of the plurality of areas included in the reliability value map. Next, the processor 130 may identify the movement path of the robot device 100 in the space based on the identified at least one area.

For example, the processor 130 may identify one movement path in which the robot device is preferentially moved in the area having the reliability value greater than or equal to the critical value among the plurality of movement paths having the same start point and end point based on the reliability value map.

For example, the processor 130 may identify one movement path bypassing the area having the reliability value less than the critical value among the plurality of movement paths having the same start point and end point based on the reliability value map.

Next, the processor 130 may move the robot device 100 based on the identified movement path.

Hereinafter, the description describes various embodiments in which the processor 130 identifies the reliability value.

FIG. 6 is a view for explaining a method of estimating the position of the robot device according to one or more embodiments of the disclosure.

Referring to FIG. 6, the processor 130 may combine (register or align) the point clouds to each other based on the first point cloud data included in the first detection data and the second point cloud data included in the second detection data, received from the LiDAR sensor.

As shown in FIG. 6, the processor 130 may combine the point clouds with each other based on the first point cloud data and the second point cloud data, corresponding to the object (e.g., sofa) adjacent to the robot device 100.

Next, the processor 130 may acquire the movement information based on a combination result, and estimate the position of the robot device 100 on the map based on the acquired movement information.

In addition, the processor 130 may acquire the movement information of the robot device 100 from the time point t to the time point t+1 by identifying commonality/similarity between the first image data included in the first detection data received from the camera and the geometric feature of the object acquired from each of the second image data included in the second detection data. In addition, the processor 130 may estimate the position of the robot device based on the movement information.

For example, the processor 130 may identify the reliability value of the area corresponding to the estimated position among the plurality of areas as greater than or equal to the critical value.

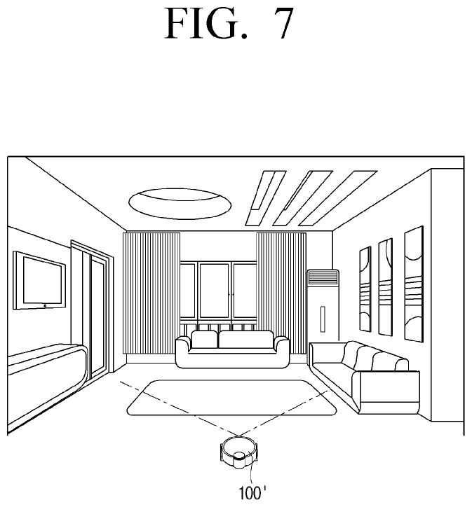

In some situations, no object may exist adjacent to the robot device 100 (or a few objects may exist adjacent to the robot device 100). In this case, the processor 130 is unable to acquire the first point cloud data and the second point cloud data, and may thus fail to combine the point clouds to each other. In this case, the processor 130 is unable to acquire the movement information based on the combination result, and may fail to estimate the position of the robot device 100 on the map. A detailed description thereof is provided with reference to FIG. 7.

FIG. 7 is a view for explaining the point cloud data according to one or more embodiments of the disclosure.

As shown in FIG. 7, in a case where a few objects exist adjacent to the robot device 100, the processor 130 may have a small number of points included in the point cloud data. Accordingly, in a case where the number of points included in the point cloud data is small, the processor 130 may identify that the reliability value of the area corresponding to the estimated position is less than the critical value.

The processor 130 according to one or more embodiments may acquire the movement information by combining the point clouds of the first point cloud data and the second point cloud data to each other, and estimate the position of the robot device 100 based on the acquired movement information. In a case where the number of points included in each of the first point cloud data and the second point cloud data is small, the processor 130 may identify that the reliability value of the area corresponding to the estimated position is less than the critical value.

In addition, in a case where each of the first point cloud data and the second point cloud data do not include any points, the processor 130 may fail to acquire the movement information and fail to estimate the position of the robot device 100 on the map.

The processor 130 may identify one movement path in which the robot device is preferentially moved through the area having the reliability value greater than or equal to the critical value among the plurality of movement paths having the same start point and end point based on the reliability value map.

For example, referring to the movement path indicated by a dotted line in FIG. 6, the movement path may include the area having a reliability value less than the critical value. Therefore, the processor 130 may identify the movement path including the movement path indicated by a solid line in FIG. 6, i.e. the area having the reliability value greater than or equal to the critical value.

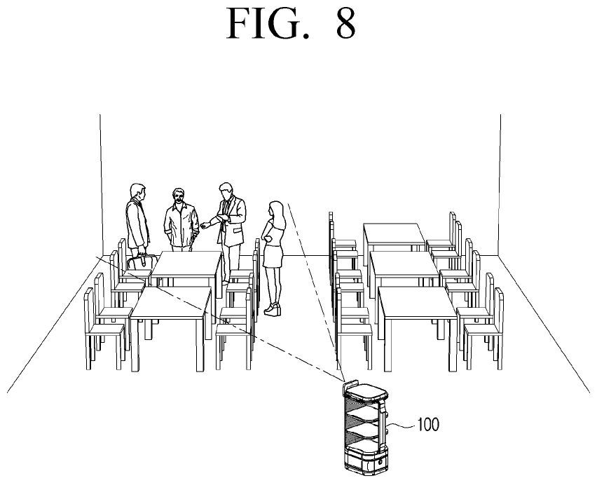

FIG. 8 is a view for explaining the dynamic object according to one or more embodiments of the disclosure.

Referring to FIG. 8, the object adjacent to the robot device 100 may be the dynamic object. In this case, the processor 130 may estimate the position of the robot device based on the point cloud data corresponding to the dynamic object, and identify that the reliability value of the area corresponding to the estimated position is less than the critical value.

For example, the processor 130 may acquire the movement information by combining the point clouds of the first point cloud data and the second point cloud data to each other, and estimate the position of the robot device 100 based on the acquired movement information. In a case where each of the first point cloud data and the second point cloud data includes a point cloud corresponding to the dynamic object, the processor 130 may identify that the reliability value of the area corresponding to the estimated position is less than the critical value.

For example, the dynamic object may be moved unlike a static object, and the movement information of the robot device 100 from the time point t to the time point t+1 may include movement of the dynamic object in addition to the movement of the robot device 100.

For example, in case of estimating the position of the robot device 100 based on the movement information, the processor 130 may estimate the position of the robot device 100 in consideration of the movement of the dynamic object in addition to the movement of the robot device 100. Therefore, an error may occur between the estimated position of the robot device 100 and its actual position. Therefore, in a case where each of the first point cloud data and the second point cloud data includes the point cloud corresponding to the dynamic object, the processor 130 may identify that the reliability value of the area corresponding to the estimated position is less than the critical value.

The sensor 120 may include the camera, and the processor 130 may identify the dynamic object based on the first image data included in the first detection data and the second image data included in the second detection data, received from the camera, and may identify that the reliability value of the area corresponding to the estimated position is less than the critical value in case of identifying the dynamic object (or identifying that the number of dynamic objects is greater than or equal to a critical number).

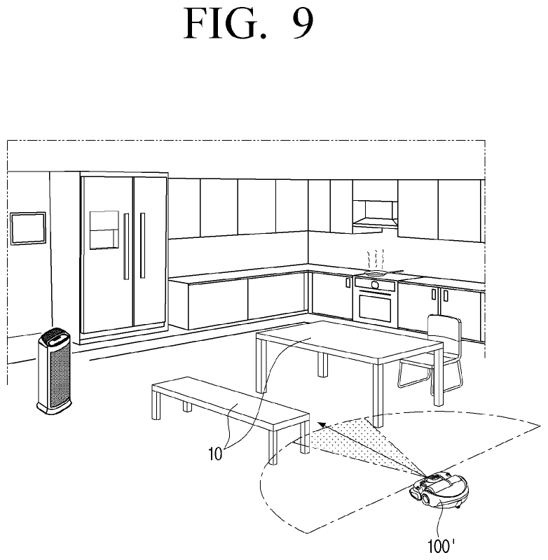

FIG. 9 is a view for explaining the field of view (FOV) according to one or more embodiments of the disclosure.

Referring to FIG. 9, the processor 130 may identify the field of view based on the detection data received from the sensor.

In a case where the identified field of view is less than the critical value, the processor 130 may identify that the reliability value of the area corresponding to the estimated position is less than the critical value.

As shown in FIG. 9, the processor 130 may identify an object (e.g., obstacle 10) positioned adjacent to a left or right direction based on a movement direction (e.g., traveling direction) of the robot device 100 based on the image data received from the camera.

Next, the processor 130 may identify the field of view of the robot device 100 based on the identified object. The processor 130 according to one or more embodiments may identify that the reliability value of the area corresponding to the estimated position from the received image data is less than the critical value in case of identifying that an angle of the field of view is less than a critical angle.

For example, in case of identifying the object positioned adjacent to the left or right direction, or the robot device 100 moved along a narrow path based on the movement direction of the robot device 100, it may be difficult for the processor 130 to identify the geometric feature of the object, the photometric feature of an object, and the like from the image data received from the camera.

For example, the processor 130 may be unable to acquire the movement information of the robot device 100 from the time point t to the time point t+1 in case of failing to identify (or having difficulty in identifying) the geometric feature of the object from each of the first image data included in the first detection data and the second image data included in the second detection data. Accordingly, the processor 130 may fail to estimate the position of the robot device 100 on the map.

In addition, the probability that the estimated position of the robot device 100 from the movement information of the robot device 100 from the time point t to the time point t+1 matches its actual position may be low in case that the processor 130 fails to identify (or having difficulty in identifying) the commonality/similarity between the geometric feature of the acquired object from each of the first image data included in the first detection data and the second image data included in the second detection data. Accordingly, the processor 130 may identify that the reliability value of the area corresponding to the estimated position is less than the critical value.

Returning to FIG. 2, the processor 130 according to one or more embodiments of the disclosure may acquire the movement information based on the number of rotations of the wheel included in the driver, a rotational speed of the wheel, or the like, in addition to the detection data received from the sensor 120.

The processor 130 according to one or more embodiments may acquire the movement information of the robot device 100 from the time point t to the time point t+1, and identify that the reliability value of the area corresponding to the estimated position is less than the critical value in case of identifying that at least one of the movement direction, movement distance, or movement speed of the robot device 100, included in the identified movement information, is impossible to be performed by the driver positioned in the robot device 100.

For example, the processor 130 may identify that the reliability value of the area corresponding to the estimated position is less than the critical value in case of identifying that the driver positioned in the robot device 100 may only be moved forward or backward, and the robot device 100 is moved to the left or right based on the movement direction of the robot device 100, included in the identified movement information.

For example, the processor 130 may identify that the reliability value of the area corresponding to the estimated position is less than the critical value in case of identifying that a maximum speed of the driver positioned in the robot device 100 is 5 m/s, and the robot device is moved at 10 m/s based on the movement distance and movement speed of the robot device 100, included in the identified movement information.

According to one or more embodiments, the processor 130 may identify the movement path based on the map and the reliability value map. In detail, the processor 130 may identify the movement path including at least one area having the reliability value greater than or equal to the critical value based on the reliability value of each of the plurality of areas included in the map.

In detail, the processor 130 may identify the movement path bypassing at least one area having the reliability value less than the critical value based on the reliability value of each of the plurality of areas included in the map.

The processor 130 may acquire the reliability value while the robot device 100 is moved along the movement path, and update the reliability value map based on the acquired reliability value.

The sensor 120 according to one or more embodiments may include the LiDAR sensor, and the processor 130 may identify an error value based on an orientation of the LiDAR sensor in any one of the plurality of areas based on the detection data received from the LiDAR sensor.

Next, the processor 130 may adjust the pose of the LiDAR sensor based on the error value while the robot device 100 is moved in one area along the movement path.

For example, the covariance value or error value of the detection data of the LiDAR sensor may depend on a direction in which the LiDAR sensor emits the laser beam at the same position.

According to one or more embodiments, the processor 130 may identify the orientation of the LiDAR sensor having a low covariance value and a low error value in a case where the robot device is moved in a specific area based on the detection data received from the LiDAR sensor.

Next, the processor 130 may adjust the orientation of the LiDAR sensor to emit the laser beam to thus have the low covariance value and the low error value rather than matching the movement direction of the robot device 100 to the orientation of the LiDAR sensor (i.e., emission direction of the laser beam), while the robot device is moved in the specific area along the movement path.

Accordingly, the movement direction of the robot device 100 and the direction in which the LiDAR sensor emits the laser beam may be the same as or different from each other.

According to various embodiments of the disclosure, the probability that the estimated position and the actual position match each other may be increased as the covariance value or the error value is decreased based on the detection data of the LiDAR sensor, and the probability that the estimated position and the actual position match each other may be increased as the number of points included in the point cloud data is increased. In addition, the probability that the estimated position and the actual position match each other may be increased as in a case where the object adjacent to the robot device 100 is not the dynamic object but the static object.

According to various embodiments of the disclosure, the probability that the estimated position and the actual position match each other may be increased as the covariance value or the error value is decreased based on the detection data of the camera, and the probability that the estimated position and the actual position match each other may be increased in case that the geometric feature of the object included in the image data or the photometric feature of the object is identified. In addition, the probability that the estimated position and the actual position match each other may be increased in a case where the object adjacent to the robot device 100 is not the dynamic object but the static object.

The processor 130 according to one or more embodiments of the disclosure may identify the movement path based on the reliability value map, thus moving the robot device 100 to be adjacent to the static object (e.g., wall, furniture, or home appliance) and by bypassing the dynamic object, in the space.

In addition, the processor 130 may identify the movement path based on the reliability value map, thus moving the robot device 100 to bypass a narrow path in the space or allowing a detection direction (e.g., pose of the LiDAR sensor) of the sensor 120 not to match the movement direction of the robot device 100 in case that the robot device is moved in the narrow path.

The robot device 100 according to one or more embodiments of the disclosure may include a communication interface. The communication interface may receive various data. For example, the communication interface may receive the various data from at least one external device positioned in the house, an external storage medium (e.g., universal serial bus (USB) memory), an external server (e.g., web hard or streaming server) or the like by using a communication method such as an access point (AP) based wireless fidelity (Wi-Fi, i.e. wireless local area network (LAN)), a Bluetooth, a Zigbee, a wired/wireless local area network (LAN), a wide area network (WAN), Ethernet, an IEEE 1394, a high definition multimedia interface (HDMI), a USB, a mobile high-definition link (MEIL), an audio engineering society/European broadcasting union (AES/EBU) communication, an optical communication, or a coaxial communication.

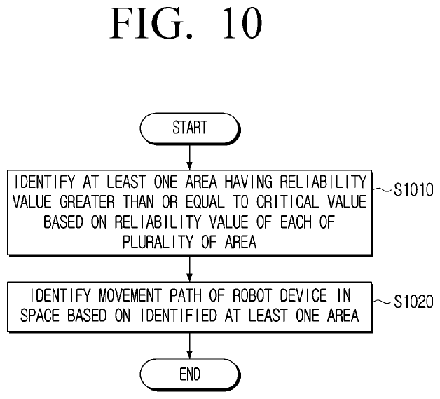

FIG. 10 is a flowchart for explaining a control method of a robot device according to one or more embodiments of the disclosure.

The control method of the robot device which includes a map of a space where the robot device is positioned and a reliability value of each of a plurality of areas included in the map according to one or more embodiments of the disclosure may first include identifying at least one area having a reliability value greater than or equal to a critical value based on the reliability value of each of the plurality of areas (S1010).

The method may then include identifying a movement path of the robot device in the space based on the identified at least one area (S1020).

The control method according to one or more embodiments may further include: estimating any one of the plurality of areas as a position of the robot device based on detection data of a sensor included in the robot device; and acquiring, as the reliability value, a probability that the estimated position of the robot device and its actual position match each other.

Here, the estimating may include: acquiring movement information of the robot device based on first detection data and second detection data in case that the first detection data and that second detection data are consecutively received from the sensor; and estimating the position of the robot device corresponding to the second detection data based on the movement information.

Here, the acquiring of the probability may include: combining point clouds to each other based on first point cloud data included in the first detection data and second point cloud data included in the second detection data, received from a LiDAR sensor; and acquiring a reliability value less than the critical value in case that the combination fails.

The acquiring of the probability according to one or more embodiments may include: identifying a dynamic object based on first image data included in the first detection data and second image data included in second detection data, received from a camera; and acquiring a reliability value less than the critical value in case that the identified number of dynamic objects is greater than or equal to a critical number.

The acquiring of the probability according to one or more embodiments may include: identifying a field of view of the camera based on image data included in the detection data received from the camera; and acquiring the reliability value less than the critical value in case that an angle of the identified field of view is less than a critical angle.

The acquiring of the probability according to one or more embodiments may include acquiring the reliability value less than the critical value in case that at least one of the movement direction, movement distance, or movement speed of the robot device included in the movement information is identified as being impossible to be performed by the robot device.

The control method according to one or more embodiments may further include updating the reliability value of any one of the plurality of areas based on the acquired reliability value.

The control method according to one or more embodiments may further include: identifying an error value based on a pose of the LiDAR sensor in one of the plurality of areas based on the detection data received from the LiDAR sensor; and adjusting the pose of the LiDAR sensor based on the error value while the robot device is moved in one area along the movement path.

The operation S1020 of identifying the movement path according to one or more embodiments may include identifying the movement path bypassing the identified area in case that the area having the reliability value less than the critical value is identified based on the reliability value of each of the plurality of areas.

However, the various embodiments of the disclosure may be applied to all movable electronic devices as well as the robot device.

The various embodiments described above may be implemented in a computer or a computer-readable recording medium using software, hardware, or a combination of software and hardware. In some cases, the embodiments described in the specification may be implemented by the processor itself. According to a software implementation, the embodiments such as the procedures and functions described in the specification may be implemented by separate software modules. Each of the software modules may perform one or more functions and operations described in the specification.

Computer instructions for performing processing operations of the robot device according to the various embodiments of the disclosure described above may be stored in a non-transitory computer-readable medium. The computer instructions stored in the non-transitory computer-readable medium may allow a specific device to perform the processing operations of the robot device 100 according to the various embodiments described above in case that the computer instructions are executed by a processor of the specific device.

The non-transitory computer-readable medium is not a medium that stores data therein for a while, such as a register, a cache, or a memory, and indicates a medium that semi-permanently stores data therein and is readable by the machine. A specific example of the non-transitory computer-readable medium may include a compact disk (CD), a digital versatile disk (DVD), a hard disk, a Blu-ray disk, a universal serial bus (USB), a memory card, a read-only memory (ROM), or the like.

Although the embodiments of the disclosure have been shown and described hereinabove, the disclosure is not limited to the above-mentioned specific embodiments, and may be variously modified by those skilled in the art to which the disclosure pertains without departing from the scope and spirit of the disclosure as disclosed in the accompanying claims. These modifications should also be understood to fall within the scope and spirit of the disclosure.

What is claimed is:

1. A robot device comprising:
at least one memory storing at least one instruction;
a sensor configured to detect an environment of the robot device and output detection data; and
at least one processor configured to execute the at least one instruction to:
acquire a map of a space where the robot device is positioned based on the detection data received from the sensor, and a reliability value of each of a plurality of areas of the map,
store the map and the reliability value of each of the plurality of areas in the at least one memory,
identify at least one area having a reliability value greater than or equal to a critical value, based on the reliability value of each of the plurality of areas, and
identify a movement path of the robot device in the space, based on the at least one area.

2. The robot device of claim 1, wherein the at least one processor is further configured to execute the at least one instruction to:
estimate, based on the detection data, an area of the plurality of areas as a position of the robot device, and
obtain an estimated reliability value corresponding to the estimated position of the robot device by determining a probability that the estimated position of the robot device and an actual position of the robot device match each other.

3. The robot device of claim 2, wherein the at least one processor is further configured to execute the at least one instruction to:
acquire movement information of the robot device based on first detection data and second detection data that are consecutively received from the sensor, and
estimate a new position of the robot device corresponding to the second detection data, based on the movement information.

4. The robot device of claim 3,
wherein the sensor comprises a light detection and ranging (LiDAR) sensor,
wherein the first detection data comprises first point cloud data received from the LiDAR sensor and the second detection data comprises second point cloud data received from the LiDAR sensor, and
wherein the at least one processor is further configured to execute the at least one instruction to:
perform an operation to combine a plurality of point clouds based on the first point cloud data and the second point cloud data, and
based on a failure of the operation to combine the plurality of point clouds, obtain an updated reliability value corresponding to the new position of the robot device, wherein the updated reliability value is less than the critical value.

5. The robot device of claim 3, wherein the sensor comprises a camera,
wherein the first detection data comprises first image data received from the camera and the second detection data comprises second image data received from the camera, and
wherein the at least one processor is further configured to execute the at least one instruction to:
identify a dynamic object based on the first image data and the second image data, and
based on a number of dynamic objects being greater than or equal to a critical number, obtain an updated reliability value corresponding to the new position of the robot device, wherein the updated reliability value is less than the critical value.

6. The robot device of claim 3, wherein the sensor comprises a camera,
wherein the detection data comprises image data received through the camera, and
wherein the at least one processor is further configured to execute the at least one instruction to:
identify a field of view of the camera based on the image data, and
based on an angle of the field of view being less than a critical angle, obtain an updated reliability value corresponding to the new position of the robot device, wherein the updated reliability value is less than the critical value.

7. The robot device of claim 3, wherein the movement information comprises a movement direction of the robot device, a movement distance of the robot device, or a movement speed of the robot device, and
wherein the at least one processor is further configured to execute the at least one instruction to:
based on identifying an inability to maintain at least one of the movement direction of the robot device, the movement distance of the robot device, and the movement speed of the robot device, obtain an updated reliability value corresponding to the new position of the robot device, wherein the updated reliability value is less than the critical value.

8. The robot device of claim 2, wherein the at least one processor is further configured to execute the at least one instruction to update, in the at least one memory, the reliability value corresponding to an area of the plurality of areas, based on the acquired reliability value.

9. The robot device of claim 2, wherein the sensor comprises a light detection and ranging (LiDAR) sensor, and
wherein the at least one processor is further configured to execute the at least one instruction to:
identify an error value based on an orientation of the LiDAR sensor in an area of the plurality of areas based on the detection data received from the LiDAR sensor, and
adjust the orientation of the LiDAR sensor based on the error value while the robot device moves along the movement path in the area of the plurality of areas.

10. The robot device of claim 1, wherein the at least one processor is further configured to execute the at least one instruction to:
based on identifying an area of the plurality of areas having a reliability value less than the critical value, modify the movement path to bypass the identified area.

11. A method of controlling a robot device, the method comprising:
acquiring a map of a space where the robot device is positioned, wherein the map comprises a plurality of areas and each area of the plurality of areas has a corresponding reliability value;
identifying at least one area, among the plurality of areas, having a reliability value greater than or equal to a critical value, based on the reliability value of each of the plurality of areas; and
identifying a movement path of the robot device in the space, based on the at least one area.

12. The method of claim 11, further comprising:
estimating, based on detection data of a sensor of the robot device, an area of the plurality of areas as a position of the robot device; and
obtaining an estimated reliability value corresponding to the estimated position of the robot device by determining a probability that the estimated position of the robot device and an actual position of the robot device match each other.

13. The method of claim 12, wherein the estimating comprises:
acquiring movement information of the robot device based on first detection data and second detection data that are consecutively received from the sensor; and
estimating, based on the movement information, a new position of the robot device corresponding to the second detection data.

14. The method of claim 13, wherein the sensor comprises a light detection and ranging (LiDAR) sensor,
wherein the first detection data comprises first point cloud data received from the LiDAR sensor and the second detection data comprises second point cloud data received from the LiDAR sensor, and
wherein the obtaining an estimated reliability value comprises:
performing an operation to combine a plurality of point clouds based on the first point cloud data and the second point cloud data; and
based on a failure of the operation to combine the plurality of point clouds, obtaining an updated reliability value corresponding to the new position of the robot device, wherein the updated reliability value is less than the critical value.

15. The method of claim 13, wherein the sensor comprises a camera,
wherein the first detection data comprises first image data received from the camera and the second detection data comprises second image data received from the camera, and
wherein the obtaining the estimated reliability value comprises:
identifying a dynamic object based on the first image data and the second image data; and
based on a number of dynamic objects being greater than or equal to a critical number, obtaining an updated reliability value corresponding to the new position of the robot device, wherein the updated reliability value is less than the critical value.

16. A non-transitory computer readable medium having instructions stored therein, which when executed by a processor cause the processor to execute a method of controlling a robot device, the method comprising:
acquiring a map of a space where the robot device is positioned, wherein the map comprises a plurality of areas, and each area of the plurality of areas has a corresponding reliability value;
identifying at least one area among the plurality of areas having a reliability value greater than or equal to a critical value, based on the reliability value of each of the plurality of areas; and
identifying a movement path of the robot device in the space, based on the at least one area.

17. The non-transitory computer readable medium of claim 16, wherein the method further comprises:
estimating, based on detection data of a sensor of the robot device, an area of the plurality of areas as a position of the robot device; and
obtaining an estimated reliability value corresponding to the estimated position of the robot device by calculating a probability that the estimated position of the robot device and an actual position of the robot device match each other.

18. The non-transitory computer readable medium of claim 17, wherein the estimating comprises:
acquiring movement information of the robot device based on first detection data and second detection data that are consecutively received from the sensor; and
estimating, based on the movement information, a new position of the robot device corresponding to the second detection data.

19. The non-transitory computer readable medium of claim 18, wherein the sensor comprises a light detection and ranging (LiDAR) sensor,
wherein the first detection data comprises first point cloud data received from the LiDAR sensor and the second detection data comprises second point cloud data received from the LiDAR sensor, and
wherein the obtaining an estimated reliability value comprises:
attempting to combine a plurality of point clouds based on the first point cloud data and the second point cloud data; and
based on a failure of the attempting to combine the plurality of point clouds, obtaining an updated reliability value corresponding to the new position of the robot device, wherein the updated reliability value is less than the critical value.

20. The non-transitory computer readable medium of claim 18, wherein the sensor comprises a camera,
wherein the first detection data comprises first image data received from the camera and the second detection data comprises second image data received from the camera, and
wherein the obtaining the estimated reliability value comprises:
identifying a dynamic object based on the first image data and the second image data; and
based on a number of dynamic objects being greater than or equal to a critical number, obtaining an updated reliability value corresponding to the new position of the robot device, wherein the updated reliability value is less than the critical value.
